(19) United States
(12) Patent Application Publication
(10) Pub. No.: US 2008/0259475 A1
(43) Pub. Date: Oct. 23, 2008

(54) Two-Mode "Grow With Me" Mirror

(75) Inventors: Mary Jean Bush, Santa Rosa Beach, FL (US); Jacquelyn R. Lynch, Hogansville, GA (US)

Correspondence Address: STEVEN C. SCHNEDLER;CARTER & SCHNEDLER, PA, 56 CENTRAL AVE., SUITE 101, PO BOX 2985, ASHEVILLE, NC, 28802, US

(73) Assignee: Blue Ridge International Products Company, Freeport, FL (US)

(21) Appl. No.: 12/104,897

(22) Filed: Apr. 17, 2008

Related U.S. Application Data
(60) Provisional application No. 60/925,567, filed on Apr. 20, 2007.

(51) Int. Cl. B60R 1/12; G02B 7/182

(52) U.S. Cl. 359/844; 359/872

(57) ABSTRACT

A two-mode mirror and entertainment device for use in vehicles, particularly for observing infants and children, and for the entertainment of infants and children. In a first mounting arrangement, a rear seating area attachment subsystem is employed to attach a mirror assembly including child entertainment devices generally near the rear seat back top surface for observing a child in a rear-facing child safety seat. When the child has grown older and is seated in a forward-facing manner, the mirror assembly including its child entertainment devices is moved so as to become a lap toy for a forward-facing seated child, typically, but not necessarily, s child in a forward-facing child seat. Two modes are provided for the child entertainment devices, selected by a mode switch. In “Mode 1” the child entertainment devices are actuated by a remote control unit. In “Mode 2” the child manually activates the entertainment devices.

### CROSS-REFERENCE TO RELATED APPLICATION

The benefit of U.S. Provisional Patent Application Ser. No. 60/925,567 filed Apr. 20, 2007 is claimed.

### BACKGROUND OF THE INVENTION

The invention generally to mirrors and entertainment devices for use in vehicles, particularly for observing infants and children, and for the entertainment of infants and children.

### SUMMARY OF THE INVENTION

In one aspect, a two-mode mirror device is provided, for use inside a vehicle including a relatively rearwardly-positioned vehicle seat with a seat back top surface, onto which vehicle seat either a rear-facing child safety seat or a forward-facing child seat may be placed. The mirror device includes a mirror assembly having a front surface with a reflective portion and with child entertainment devices; a rear seating area attachment subsystem for attaching the mirror assembly generally near the seat back top surface for use when and in the event a child is in a rear-facing child safety seat; and a lap attachment subsystem for attaching the mirror assembly to a forward-facing child seat generally over the lap of a child in a forward-facing child seat for use when and in the event a child is in the forward-facing car seat.

In another aspect, a two-mode mirror device is provided, for use inside a vehicle including a relatively rearwardly-positioned vehicle seat with a seat back top surface, onto which vehicle seat at least a rear-facing child safety seat may be placed. The mirror device includes a mirror assembly having a front surface with a reflective portion and with child entertainment devices, and having a mode switch for selecting either “Mode 1” or “Mode 2” operation. The mirror device also includes a remote control unit. A rear seating area attachment subsystem is provided for attaching the mirror assembly generally near the seat back top surface for use when and in the event a child is in a rear-facing child safety seat. The mirror assembly with child entertainment devices also is usable in the lap of a forward-facing seated child when and in the event a child is so seated. When “Mode 1” is selected, the entertainment devices are responsive to activation by the remote control unit, intended for use when the mirror assembly is attached generally near the seat back top surface for use when a child is in a rear-facing child safety seat. When “Mode 2” is selected, the entertainment devices are responsive to activation by manual contact intended for use when the mirror assembly is in the lap of a forward-facing seated child.

### BRIEF DESCRIPTION OF THE DRAWINGS

FIG. 1 is a diagrammatic illustration of a vehicle with a mirror device embodying the invention attached generally near the seat back top surface employing a headrest mounting attachment for observing an infant in a rear-facing child safety seat secured to the rear seat of the vehicle;

FIG. 2 is an enlarged view of the mirror device positioned as in FIG. 1;

FIG. 3 is a mirror device embodying the invention attached to a forward-facing child seat generally over the lap of the child;

FIG. 4 is an exploded view from the rear of a mirror device embodying the invention shown from the rear;

FIG. 5 shows a mirror device embodying the invention attached generally near the seat back top surface employing a rear deck attachment for use in the event a child is in a rear-facing child safety seat;

FIG. 6 is an enlarged view, corresponding to FIG. 3, showing attachment of the mirror device to a forward-facing child seat; and

FIG. 7 is an enlarged view of the clip shown in FIG. 6.

### DETAILED DESCRIPTION

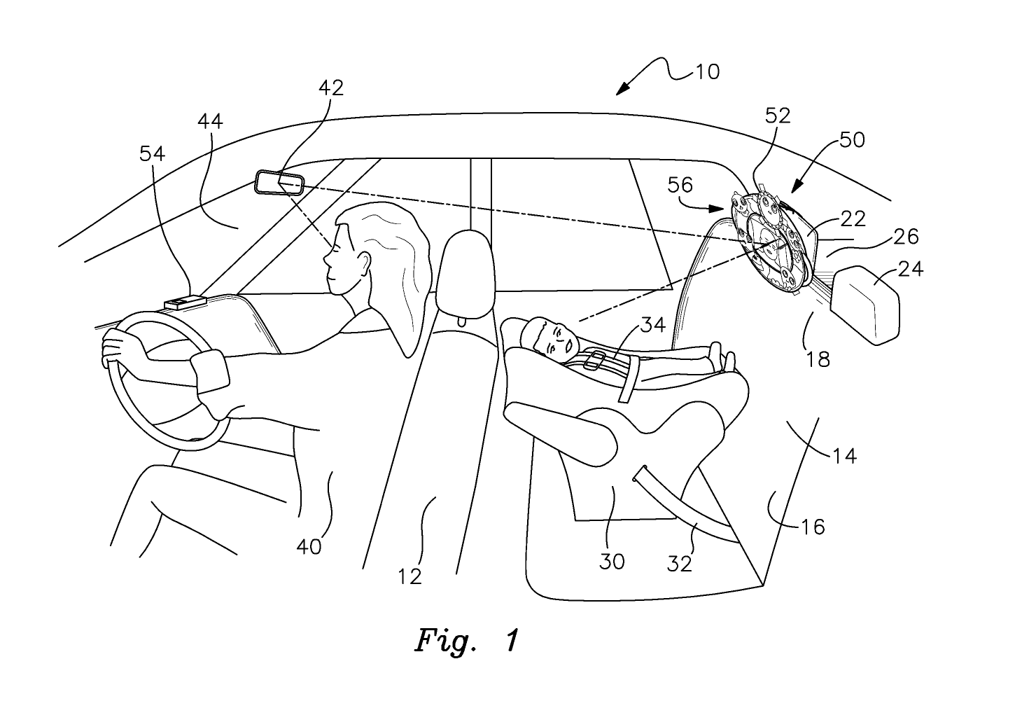

Referring first to FIG. 1, represented is a vehicle 10 in the form of an automobile 10 including a front vehicle seat 12 and a rearwardly-positioned vehicle seat 14. In FIG. 1, the seat 14 is the rear vehicle seat, since there are only front and rear seats and no intermediate seats in the particular vehicle 10 of FIG. 1.

The rear vehicle seat 14 has a seat back 16 with a top surface 18. Three headrests 20, 22 and 24 project upwardly from the top surface 18. Behind the seat back 16, and extending up to a rear window (not shown), is a rear shelf 26, which may also be referred to as a rear filler panel 26.

In the FIG. 1 embodiment, on and secured to the rear vehicle seat 14 is a rear-facing child safety seat 30 secured by a seatbelt assembly 32 in a conventional manner. A child 34 is seated in the rear-facing child safety seat 30.

In the front vehicle seat 12 is a driver 40 who may wish to observe the child 34. A conventional rearview mirror 42 is attached to the vehicle front windshield 44, but this rearview mirror 42 alone is not sufficient for observing the face of the child 34 since the child 34 is facing the rear. Accordingly, a variety of mirror devices are available, generally in the form of a mirror mounted in some manner generally near the rear seat back top surface 18 in such a way that the driver 40 can observe the face of the child 34 by looking in the rearview mirror 42. Thus, and by way of example, mirror attachment systems are disclosed in Kane U.S. Pat. Nos. 6,857,753 and 6,913,364; Kane et al U.S. Pat. No. 7,104,661; and Darling U.S. Pat. No. 7,097,314; the entire disclosures of which are hereby expressly incorporated by reference.

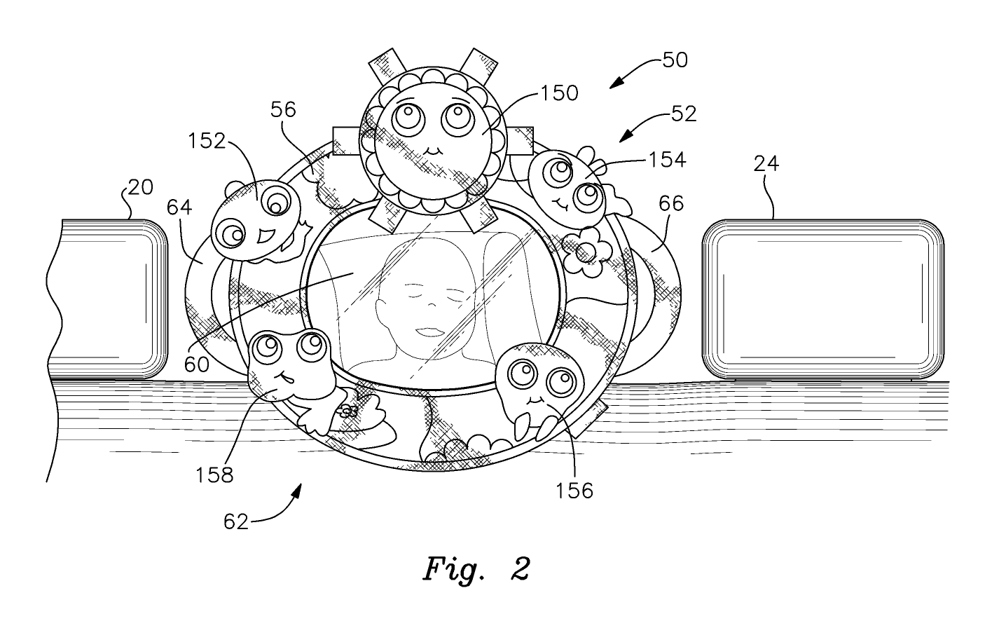

With reference to FIGS. 2, 3, 4 and 5 in addition to FIG. 1, a two-mode mirror device is generally designated 50. As described in greater detail hereinbelow, the mirror device 50, has two distinct mounting arrangements and two generally corresponding operational modes.

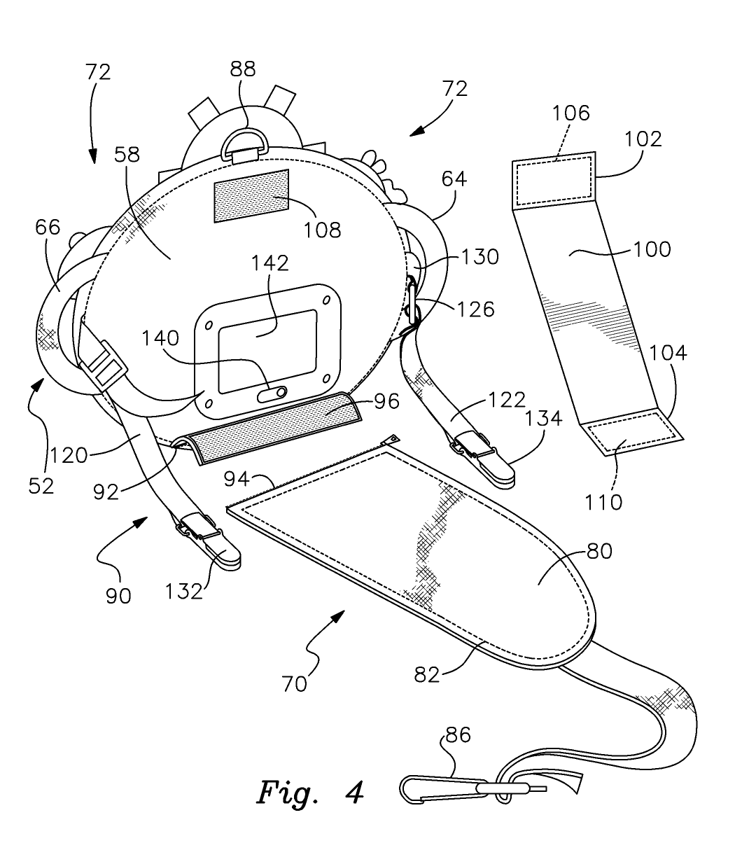

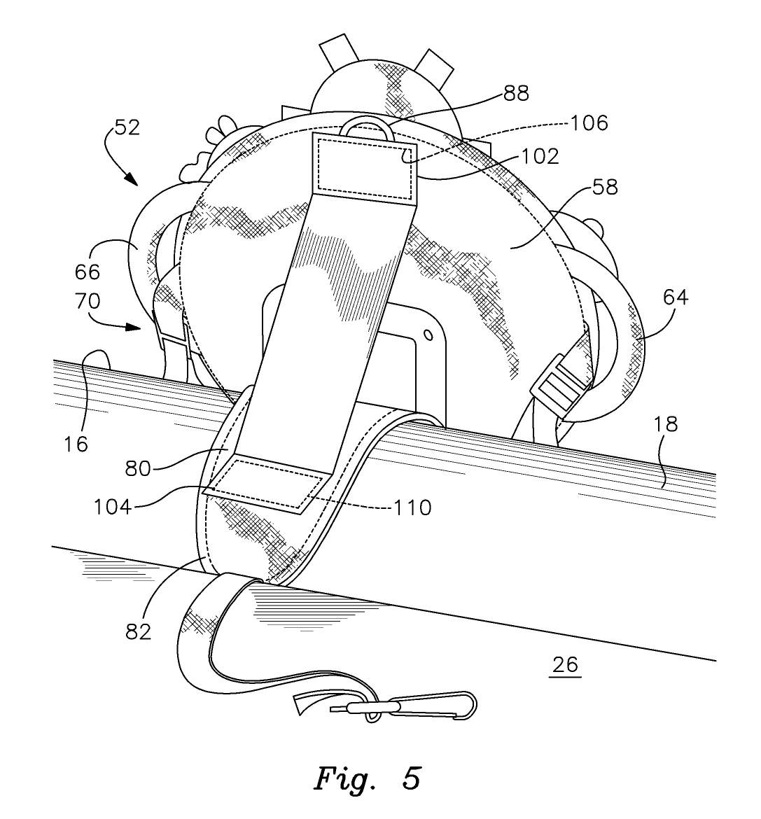

The two-mode mirror device 50 more particularly includes a mirror assembly 52 and a separate remote control unit 54 located so as to be accessible to the driver 40. The mirror assembly 52 includes a front surface 56 (visible in FIGS. 1, 2 and 3), as well as a rear surface 58 (visible in FIGS. 4 and 5). The front surface 56 includes a reflective portion 60, i.e. a mirror surface 60. The mirror assembly 52 additionally includes child entertainment devices, generally designated 62, and also described in greater detail hereinbelow. The mirror assembly 52 has side handles 64 and 66 which facilitate handling.

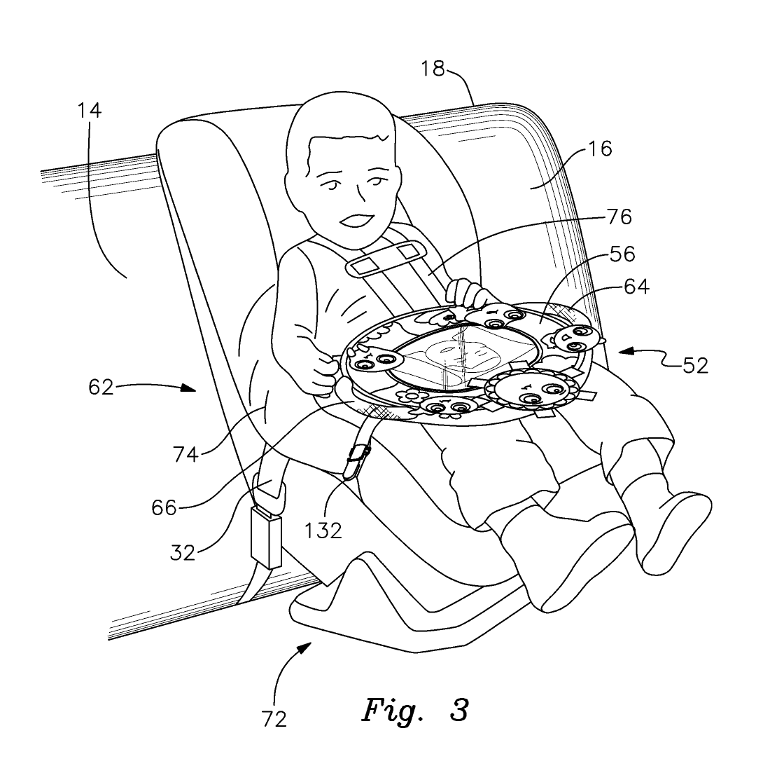

In overview, the mirror device 50 additionally includes two attachment subsystems corresponding to the two mounting arrangements. Thus, a rear seating area attachment subsystem, generally designated 70, is provided for attaching the mirror assembly 52 generally near the rear seat back top surface 18 for use when and in the event a child 34 is in a rear-facing child safety seat 30 as shown in FIGS. 1 and 2. In addition, a lap attachment subsystem, generally designated 72, is provided for attaching the mirror assembly 52 to a forward-facing child seat 74, as illustrated in FIG. 3. FIG. 3 more particularly shows a child 76 in the forward-facing child seat 74. The forward-facing child seat 74 is on the rear seat 14, but in a forward-facing direction (unlike FIG. 1), and is secured by the seatbelt assembly 32.

Accordingly, in the first mounting arrangement, the rear seating area attachment subsystem 70 is employed to attach the mirror assembly 52 generally near the rear seat back top surface 18, for observing the child 34 in the rear-facing child safety seat 30 (e.g. FIG. 1). When a child has grown older and is seated in a forward-facing manner, the mirror assembly 52 including its child entertainment devices 62 is moved so as to become a lap toy for a forward-facing seated child, typically, but not necessarily, the child 76 in the forward-facing child seat. When the mirror assembly 52 including its child entertainment devices 62 is employed as a lap toy, the rear seating area attachment subsystem 70 is removed. The lap attachment subsystem 72 may or may not be employed when the mirror assembly is employed as a lap toy.

With particular reference to the exploded rear view of FIG. 4, elements of the rear seating area attachment subsystem 70 and of the lap attachment subsystem 72 are shown in greater detail. The rear seating area attachment subsystem 70 is generally as disclosed in the above-incorporated Kane U.S. Pat. Nos. 6,857,753 and 6,913,364 and Darling U.S. Pat. No. 7,097,314, but with modifications such that the rear seating area attachment subsystem 70 is at least in part removable.

The rear seating area attachment subsystem 70 more particularly includes a lower panel 80 which, during use, either contacts the rear seat back top surface 18 (as shown in FIG. 5), or wraps around one of the headrests 20, 22 or 24 (as in FIGS. 1 and 2). The lower panel 80 includes a wire stiffener 82 so that it can serve as a clamp. Extending from the lower panel 80 is an adjustable strap 84 terminating in a clip 86. Depending upon the particular mounting configuration, the clip 86 may be attached to a vehicle tether anchor, may be attached to a D-ring 88 at the top of the mirror assembly 52 in the event the lower panel 80 is wrapped around a headrest 20, 22 or 24 (as in FIGS. 1 and 2), or may be unused (as in FIG. 5).

The lower panel 80 is made of a fabric which can function as the “loop” part of a hook-and-loop fastener system. The lower panel 80 is removably attached to the rear surface 58 of the mirror assembly 52 by a zipper 90 having two sides 92 and 94, as well as by a flap 96 sewn to the rear surface 58 of the mirror assembly 52. The underside of the flap 96 includes the “hook” element of a hook-and-loop fastener, for engagement with the top surface of the lower panel 80. On the underside of the lower panel 80 is a rubber friction pad (not shown) with a friction-enhancing textured surface for engaging the top surface 18 of the seat back 16.

The rear seating area attachment subsystem 70 additionally includes a diagonal support element 100, which may also be referred to as an adjustable stand 100, which extends between the rear surface 58 of the mirror assembly 52 at an upper end 102 of the diagonal support element 100 and the top surface of the lower panel 80 at a lower end 104 of the diagonal support element 100. The diagonal support element 100 is shown in use in the configuration of FIG. 5, but is not employed in the headrest attachment configuration of FIGS. 1 and 2.

The diagonal support element 100 is entirely removable. At its upper end 102 the diagonal support element includes a “hook” material piece 106 for removable engagement with a “loop” material piece 108 located near the top of the rear surface 58 of the mirror assembly 52, the two pieces 106 and 108 together being a hook-and-loop fastener system. The lower end 104 of the diagonal support element 100 includes another “hook” material piece 110 which cooperates with the upper surface of the lower panel 80 to also function as a hook-and-loop fastener system. The lower end 104 of the diagonal support element 100 can be attached at various positions along the lower panel 80 for adjustment purposes.

The rear seating area attachment subsystem 70 may be used in a number of configurations, again generally as disclosed in the above-incorporated Kane U.S. Pat. Nos. 6,857,753 and 6,913,364 and Darling U.S. Pat. No. 7,097,314. Thus, FIGS. 1 and 2 depict a headrest attachment configuration, while FIG. 5 depicts a rear deck attachment. In FIG. 5, the lower panel 80 with its wire stiffener 82 is conformed to the seat back 16 top surface 18, and may be tucked in between the seat back 16 and rear panel 26 or rear deck 26.

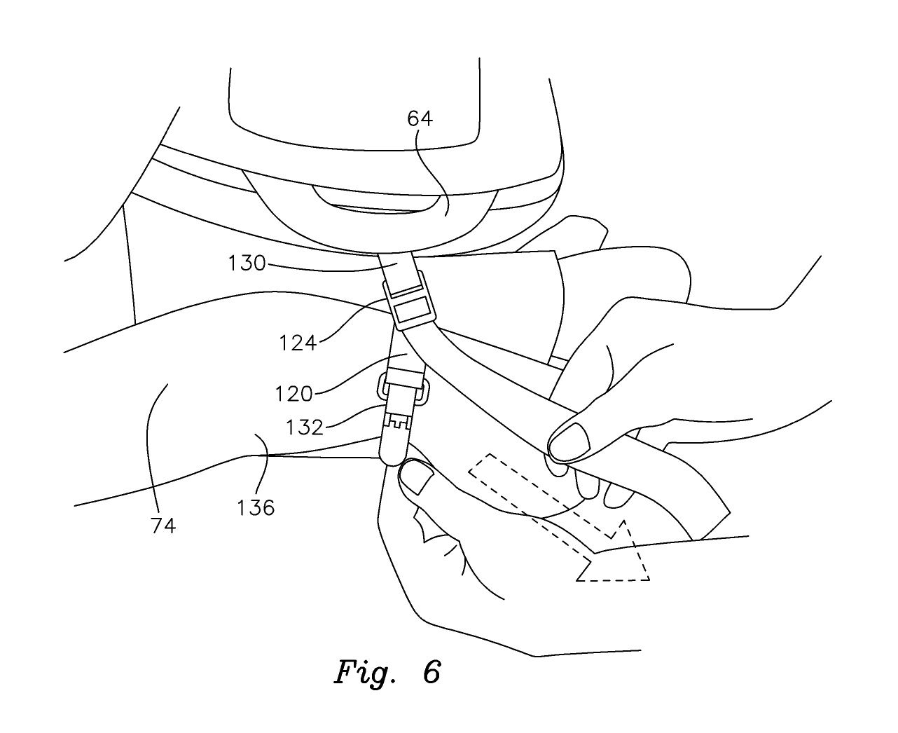

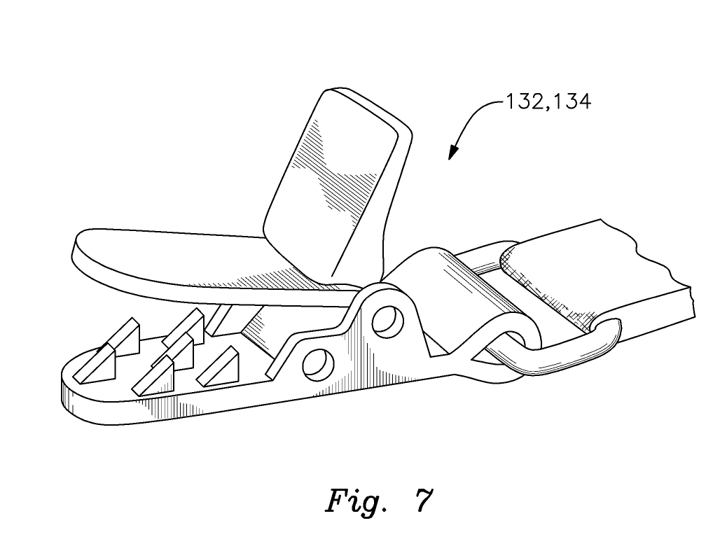

With reference to FIG. 4 as well as to FIGS. 3, 5, 6 and 7, the lap attachment subsystem 72 more particularly includes a pair of straps 120 and 122 connected by adjustment buckles 124 and 126 to the sides of the mirror assembly 52. In the illustrated embodiment, the adjustment buckles 124 and 126 are connected to the mirror assembly 52 by short loops of webbing 128 and 130 sewn to the mirror assembly 52. The straps 120 and 122 terminate in attachment clips 132 and 134, one of which is shown in enlarged detail in FIG. 7. FIG. 6 illustrates the manner in which the attachment clips 132 and 134 of the lap attachment subsystem 72 are employed to attach the straps 120 and 122 to a fabric portion 136 of the forward-facing child seat 74. When the mirror assembly 52 is attached to the forward-facing child seat 74 as in FIGS. 3 and 6, the elements of the rear seating area attachment subsystem 70 are not employed, and typically are removed.

As noted above, the mirror assembly 52 includes entertainment devices, generally designated 62. Two modes are provided, selected by a mode switch 140 as part of an electronics subassembly 142 on the back of the mirror assembly 52, as illustrated in FIG. 4. The electronic subassembly 142 includes batteries (not shown) and conventional electronic circuitry (not shown) to drive a speaker (not shown) hidden within the mirror assembly 52, as well as to operate at least one flashing light.

In “Mode 1” the child entertainment devices 62 are actuated by the remote control unit 54. “Mode 1” is intended to be employed when the mirror assembly 52 is attached generally near the seat back top surface 18 for observing the child 34 in the rear-facing child safety seat 30 as illustrated in FIGS. 1 and 5. Thus, periodically, the driver 40 activates the child entertainment devices 62.

“Mode 2” is employed when a child has grown older, and is in a forward-facing child seat 74 as in FIG. 3. In “Mode 2” the remote control unit 54 is no longer used, and the child 76 manually activates the child entertainment devices 62.

By way of example and not limitation, the child entertainment devices 62 take the form of light and sound features. By way of example, a blinking sun character 150 includes a blinking light (hidden beneath the fabric surface), as well as a touch switch (also hidden). The light and switch are connected to circuitry within the electronic subassembly 142 such that, when the sun character 150 is activated, music plays, and the light flashes in synchronization with the music.

Other entertainment devices include a bird character 152, a bee character 154, a cricket character 156, as well as a frog character 158. Respective touch switches are hidden within each of the characters 152, 154, 156 and 158 such that, when activated in “Mode 2”, the child hears either the name and sound of each character, or a special song for each character, played via circuitry within the electronic subassembly 142 through the hidden speaker.

For example, if a child presses the blinking sun character 150, music plays, and the sun character 150 flashes in synchronization with the music. If the child presses the bird character 152, electronics within the subassembly 142 play “What does a bird say? Tweet. Tweet. Bird.” If the child presses the bee character 154, the child hears, “What does a bee say?Buzz. Buzz. Bee.” Upon a subsequent press, the music “Flight of the Bumble Bee” is played.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. A two-mode mirror device for use inside a vehicle including a relatively rearwardly-positioned vehicle seat with a seat back top surface, onto which vehicle seat either a rear-facing child safety seat or a forward-facing child seat may be placed, said mirror device comprising:
a mirror assembly having a front surface with a reflective portion and with child entertainment devices;
a rear seating area attachment subsystem for attaching said mirror assembly generally near the seat back top surface for use when and in the event a child is in a rear-facing child safety seat; and
a lap attachment subsystem for attaching said mirror assembly to a forward-facing child seat generally over the lap of a child in a forward-facing child seat for use when and in the event a child is in the forward-facing car seat.

2. The device of claim 1, wherein said rear seating area attachment subsystem is at least in part removable.

3. The device of claim 1, wherein said child entertainment devices include lights and sounds.

4. The device of claim 1, which further comprises:
said mirror assembly including a mode switch for selecting either “Mode 1” or “Mode 2” operation; and
a remote control unit;
said entertainment devices being responsive to activation by said remote control unit when “Mode 1” is selected, and said entertainment devices being responsive to activation by manual contact when “Mode 2” is selected.

5. The device of claim 3, which further comprises:
said mirror assembly including a mode switch for selecting either “Mode 1” or “Mode 2” operation; and
a remote control unit;
said entertainment devices being responsive to activation by said remote control unit when “Mode 1” is selected, and said entertainment devices being responsive to activation by manual contact when “Mode 2” is selected.

6. A two-mode mirror device for use inside a vehicle including a relatively rearwardly-positioned vehicle seat with a seat back top surface, onto which vehicle seat at least a rear-facing child safety seat may be placed, said mirror device comprising:
a mirror assembly having a front surface with a reflective portion and with child entertainment devices, and said mirror assembly including a mode switch for selecting either “Mode 1” or “Mode 2” operation;
a remote control unit; and
a rear seating area attachment subsystem for attaching said mirror assembly generally near the seat back top surface for use when and in the event a child is in a rear-facing child safety seat;
said mirror assembly with child entertainment devices also being usable in the lap of a forward-facing seated child when and in the event a child is so seated;
said entertainment devices being responsive to activation by said remote control unit when “Mode 1” is selected, intended for use when said mirror assembly is attached generally near the seat back top surface for use when a child is in a rear-facing child safety seat, and said entertainment devices being responsive to activation by manual contact when “Mode 2” is selected, intended for use when said mirror assembly is in the lap of a forward-facing seated child.

7. The device of claim 6, wherein said rear seating area attachment subsystem is at least in part removable.

8. The device of claim 6, wherein said child entertainment devices include lights and sounds.

9. The device of claim 7, wherein said rear seating area attachment subsystem is at least in part removable.
